(19) United States
(12) Patent Application Publication
(10) Pub. No.: US 2015/0241299 A1
(43) Pub. Date: Aug. 27, 2015

(54) DETERMINING A LEG LOAD OF A JACK-UP VESSEL

(71) Applicant: SIEMENS AKTIENGESELLSCHAFT, 80333 München (DE)

(72) Inventors: Jörg Deckers, Dinslaken (DE); Martin Willer, Duisburg (DE)

(73) Assignee: SIEMENS AKTIENGESELLSCHAFT, 80333 münchen (DE)

(21) Appl. No.: 14/432,700

(22) PCT Filed: Oct. 1, 2013
(86) PCT No.: PCT/EP2013/070400

§ 371 Date: Mar. 31, 2015

(30) Foreign Application Priority Data
Oct. 1, 2012 (DE) 10 2012 217 880.5

(51) Int. Cl. G01M 5/00; B66F 3/02; G01L 1/22; E02B 17/08

(52) U.S. Cl. CPC G01M 5/0058; E02B 17/0818; B66F 3/02; G01L 1/22

(57) ABSTRACT

A method for determining a leg load acting on a support leg that can be lowered by a rack-and-pinion drive of a jack-up vessel has a supporting structure for at least one gear unit of the rack-and-pinion drive. At least one strain gauge is arranged on the supporting structure to detect the strain in the supporting structure caused by the leg load. Any strain in the supporting structure is detected with the at least one strain gauge and the leg load is determined from the detected strain. A lifting device for a lowerable support leg of a jack-up vessel with a measuring device for determining a leg load acting on the support leg is also described.

The invention relates to a method for determining a leg load which acts on a support leg of a jack-up vessel, said support leg being lowerable by means of a rack and pinion drive, as well as a lifting device for a lowerable support leg of a jack-up vessel.

In this case, so-called jack-up vessels and jack-up platforms are combined together in the term “jack-up vessels”. Here, a jack-up vessel is understood as a vessel with a separate drive which has lowerable support legs (so-called jack-up legs), on which it is able to be positioned on the floor of a body of water. “Jack-up platform” is understood as a floating platform without a separate drive which has lowerable support legs, on which it is able to be positioned on the floor of a body of water. Jack-up vessels are used, for example, for erecting offshore wind energy plants or offshore drilling platforms for the production of oil or natural gas.

“Lifting device for a lowerable support leg of a jack-up vessel” is understood as a device by means of which the support leg may be lowered to the floor of the body of water and lifted up therefrom.

Both during and after the positioning of the support legs of a jack-up vessel on the floor of a body of water, it is extremely useful to provide information and monitoring of the leg loads respectively loading the support legs as accurately as possible in order to achieve, to monitor and to reproduce if necessary a secure foundation of the jack-up vessel on the floor of the body of water.

The object of the invention is to specify an improved method for determining a leg load which acts on a support leg of a jack-up vessel, said support leg being lowerable by means of a rack and pinion drive. The object of the invention is also to specify a lifting device for a lowerable support leg of a jack-up vessel which permits improved determination of a leg load acting on the support leg.

The object is achieved according to the invention with regard to the method by the features of claims 1 and 11, and with regard to the lifting device by the features of claim 7.

Advantageous embodiments of the invention form the subject matter of the subclaims.

A leg load which acts on a support leg of a jack-up vessel, said support leg being able to be lowered by means of a rack and pinion drive, is determined by means of the method according to the invention, wherein the jack-up vessel has a supporting structure for at least one gear unit of the rack and pinion drive. In this case, at least one strain gauge is arranged on the supporting structure for detecting the strain in the supporting structure caused by the leg load. Strain in the supporting structure is detected by means of the at least one strain gauge and the leg load is determined from the detected strain.

The method according to the invention makes use of the fact that a leg load acting on a support leg produces stresses in the supporting structure as the supporting structure is coupled to the support leg via one or more gear units of the rack and pinion drive. The stresses in the supporting structure cause strain in the supporting structure which are detected according to the invention by means of at least one strain gauge and evaluated for determining the leg load.

According to the invention, therefore, a supporting structure which is fixedly connected to the jack-up vessel is used as a primary sensor element for determining the leg load by means of strain gauges. This has advantages relative to the use of mobile or movably suspended structures, such as for example torque measuring shafts on pinion shafts of gear units of a rack and pinion drive, in that a more robust construction is used whereby the sensitivity to interference of the measurements is reduced and the measuring accuracy increased. Moreover, the determination according to the invention of leg loads acting on a support leg of a jack-up vessel by means of strain gauges arranged on the supporting structures is substantially simpler and more cost-effective than, for example, methods which use expensive and sensitive load cells or torque measuring shafts.

One embodiment of the invention provides that a plurality of strain gauges are arranged on the supporting structure and electrically connected together such that measuring signals of these strain gauges caused by bending stresses and/or torsional stresses and/or temperature changes in the supporting structure mutually compensate one another.

As a result, merely by a suitable arrangement and connection of the strain gauges, it is advantageously achieved in a simple manner that bending stresses or torsional stresses or temperature changes in the supporting structure do not falsify or unnecessarily complicate the determination of the leg loads.

Preferably, at least one pair of strain gauges is arranged on the supporting structure such that the strain gauges of the pair detect the strain in the supporting structure in different directions and the strain gauges of each pair are electrically connected to a half bridge.

As a result, it is achieved for example that strain in the supporting structure produced by temperature changes does not influence the measurement result, as temperature changes generally cause strain irrespective of the direction and therefore may be compensated by the variable alignment of two strain gauges connected to a half bridge.

One embodiment of the invention provides in this case that at least two pairs of strain gauges electrically connected to a half bridge are arranged on the supporting structure such that the strain gauges of each pair detect the strain in the supporting structure in different directions and in that the strain in the supporting structure detected by different pairs is averaged for determining the leg load.

By averaging the measurement results of at least two different pairs of strain gauges connected to a half bridge, it is advantageously possible to reduce measuring errors which are caused by stresses occurring sporadically and locally at the locations of individual strain gauges.

A particularly preferred embodiment of the invention provides that at least two pairs of strain gauges electrically connected to a half bridge are arranged on the supporting structure such that the strain gauges of each pair detect the strain in the supporting structure in different directions, and such that at least two of these pairs are electrically connected to a Wheatstone full bridge for detecting the strain in the supporting structure caused by the leg load.

As a result, the known advantages of the Wheatstone bridge circuit may be used for improving the measuring accuracy and for compensating for bending stresses and torsional stresses and temperature effects. Thus, when using the same strain gauges, the measurement voltage of the Wheatstone full bridge disappears if all of the strain gauges are unexpanded. If, however, some of these strain gauges are expanded or compressed, the measurement voltage generally alters to positive or negative values as a result of alterations to the electrical resistances of the strain gauges caused by the strain. The different alignment of the two strain gauges in the half bridges of the full bridge permits the reduction of measurement errors which are caused by bending stresses or torsional stresses or temperature changes.

A further embodiment of the invention provides that each strain gauge is arranged on a supporting structure region of the supporting structure which is free from notch stresses.

“Notch stresses” in this case are understood as excess stresses in the supporting structure which occur at notch-like weak points (including weld seams) of the supporting structure.

The arrangement of the strain gauges on supporting structure regions which are free from notch stresses has the advantageous effect that the measurements of strain in a supporting structure are not influenced by such notch stresses.

A lifting device according to the invention for a lowerable support leg of a jack-up vessel, wherein the support leg has at least one toothed rack extending parallel to a longitudinal axis of the support leg, comprises a rack and pinion drive having at least one gear unit for a toothed rack of the support leg, a supporting structure which has at least one supporting frame on which at least one gear unit of the rack and pinion drive is arranged and a measuring device for determining a leg load acting on the support leg. In this case, the measuring device comprises at least one strain gauge arranged on a supporting frame for detecting the strain in the supporting frame caused by the leg load and a control unit electrically connected to the at least one strain gauge for determining the leg load from measuring signals of the at least one strain gauge.

The lifting device according to the invention permits the use of the method according to the invention for determining the leg load from measuring signals with the above-mentioned advantages in that it comprises a corresponding measuring device. The lifting device thus permits an improved determination and monitoring of the respective leg loads loading the support legs, during and after the positioning of the support legs of a jack-up vessel on the floor of a body of water, and thereby improves the security of the foundation of the jack-up vessel on the floor of the body of water.

One embodiment of the lifting device provides that at least one supporting frame has a rear wall and two side walls angled back from the rear wall, wherein at least one gear unit of the rack and pinion drive is arranged on the rear wall and at least one strain gauge of the measuring device is arranged on each side wall.

This embodiment of the lifting device is particularly advantageous if the side walls have supporting structure regions which, on the one hand, are free of notch stresses so that the measurements are not influenced by such notch stresses and in which, on the other hand, stresses which are as high possible are nevertheless produced by a leg load in order to achieve sufficient measuring accuracy.

In this case, at least one pair of strain gauges of the measuring device electrically connected to a half bridge is preferably arranged on each side wall of at least one supporting frame.

Particularly preferably, in this case at least two pairs of strain gauges connected to a half bridge and arranged on different side walls of a supporting frame are also electrically connected to a Wheatstone full bridge.

These arrangements and connections of the strain gauges have the aforementioned advantages that they permit the influences of bending stresses, torsional stresses and/or temperature changes to be compensated.

The invention provides, in particular, the use of the method according to the invention for determining a leg load which acts on a support leg of a jack-up vessel, said support leg being lowerable by means of a lifting device according to the invention, wherein the leg load is determined by means of the measuring device of the lifting device.

The above-described properties, features and advantages of this invention and the manner in which they are achieved become clearer and more easily comprehensible in association with the following description of exemplary embodiments which are described in more detail in combination with the drawings, in which:

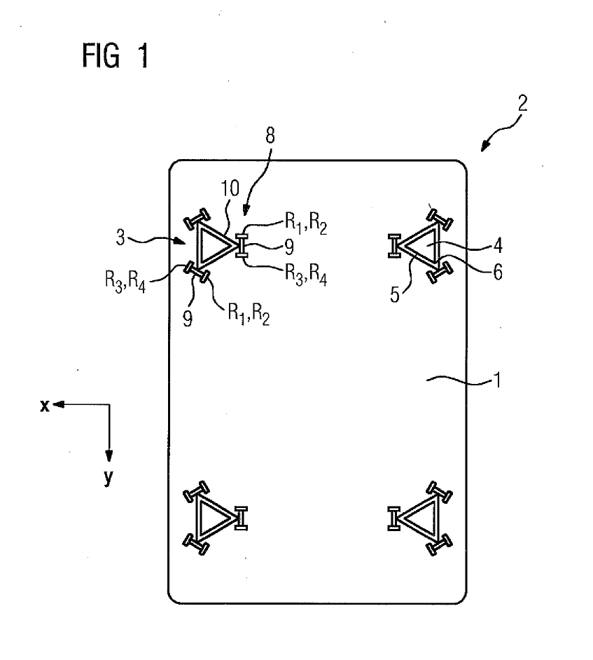

FIG. 1 shows schematically in a plan view a deck of a jack-up vessel with four lifting devices for lowerable support legs of the jack-up vessel,

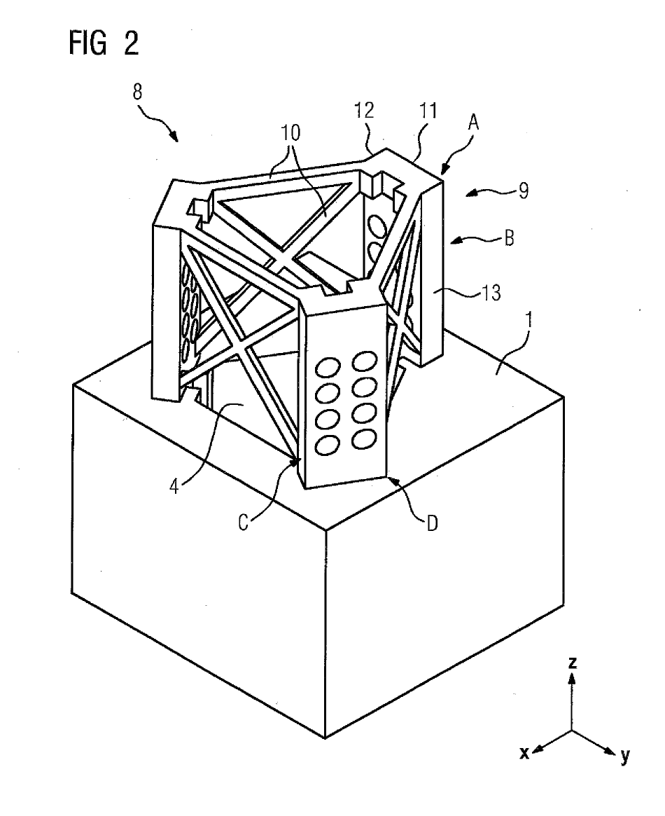

FIG. 2 shows in a perspective view a supporting structure of a lifting device for a lowerable support leg of a jack-up vessel,

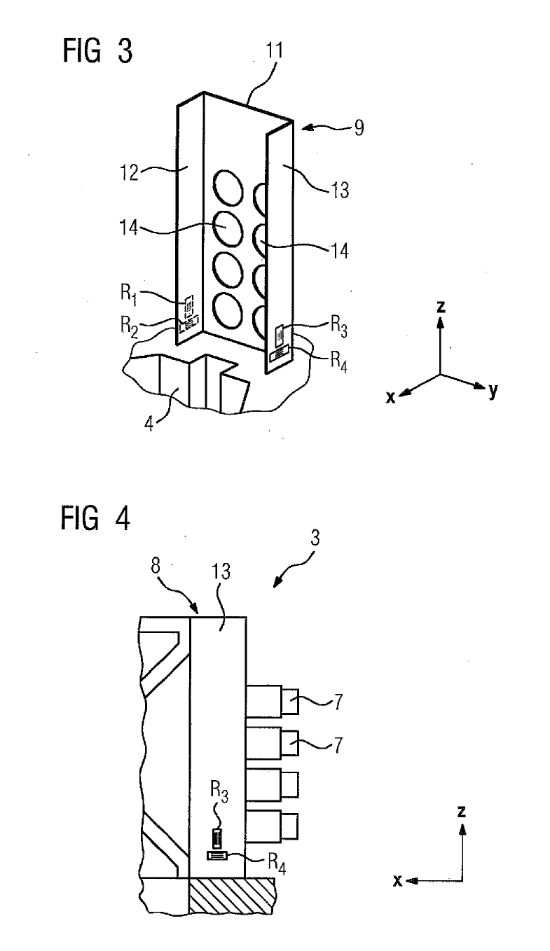

FIG. 3 shows schematically in a perspective view a supporting frame of a supporting structure of a lifting device for a lowerable support leg of a jack-up vessel and strain gauges arranged on the supporting frame for determining a leg load acting on the support leg,

FIG. 4 shows a detail in a side view of a lifting device for a lowerable support leg of a jack-up vessel, and

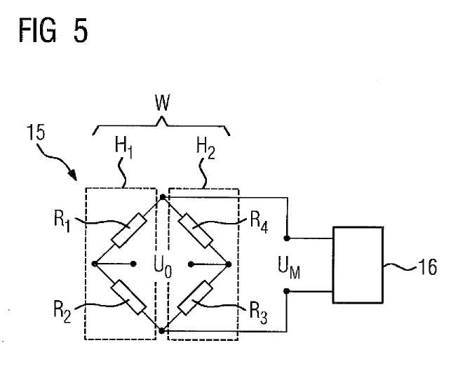

FIG. 5 shows schematically and in detail a measuring device for determining a leg load acting on a support leg of a jack-up vessel.

Parts which correspond to one another are provided with the same reference numerals in all of the figures.

FIG. 1 shows schematically in a plan view a deck 1 of a jack-up vessel 2 with four lifting devices 3 for lowerable support legs 5 of the jack-up vessel 2.

The deck 1 has a substantially rectangular contour with four corners. In the vicinity of each corner, the deck 1 has a deck opening 4 for passing through a support leg 5 and a lifting device 3 for lowering and lifting this support leg 5.

Each support leg 5 is configured as a lattice-like framework structure, the envelope thereof approximately having the structure of a prism with a triangular footprint. Each support leg 5 has three toothed racks which extend parallel to one another, in each case along one of the three vertical support leg edges 6 of the support leg 5.

Each lifting device 3 comprises a rack and pinion drive cooperating with the toothed rack of the respective support leg 5, for lowering and lifting the support leg 5. The rack and pinion drive for each toothed rack of the support leg 5 has eight gear units 7, not shown in more detail in FIG. 1 (see FIG. 4). Moreover, each lifting device 3 has a support structure 8 for the gear units 7 of its rack and pinion drive, said support structure at the same time serving as a guide for the respective support leg 5 and being erected on the deck 1 around the deck opening 4 for the support leg 5.

FIG. 2 shows the supporting structure 8 of a lifting device 3 schematically in a perspective view. The supporting structure 8 has three supporting frames 9 which are connected together by connecting elements 10. The supporting frames 9 in each case are arranged adjacent to one of the support leg edges 6 of the respective support leg 5, so that a longitudinal axis of the supporting frame 9 extends parallel to this support leg edge 6 and thus also parallel to the toothed rack of the support leg 5 extending along this support leg edge 6.

FIG. 3 shows schematically in a perspective view a supporting frame 9 of a supporting structure 8. The supporting frame 9 has a rear wall 11 and two side walls 12, 13 angled back from the rear wall 11. The rear wall 11 has eight rear wall openings 14 which are configured for receiving in each case a gear unit 7 of the rack and pinion drive of the associated lifting device 3. The rear wall openings 14 are arranged in the form of a matrix with two columns arranged adjacent to one another, wherein each column has four rear wall openings 14 arranged on top of one another.

Two strain gauges R₁ to R₄ of a measuring device 15 (see FIG. 5) are arranged on each side wall 12, 13 for determining a leg load acting on the associated support leg 5.

FIG. 4 shows a lifting device 3 for a support leg 5 in detail in a side view. A supporting structure 8 is shown, in each case two strain gauges R₁ to R₄ being arranged on the side walls thereof 12, 13 and the rear wall 11 thereof bearing eight gear units 7 in rear wall openings 14 provided therefor.

FIG. 5 shows schematically and in detail a measuring device 15 for determining a leg load acting on a support leg 5 of the jack-up vessel 2. The measuring device 15 is part of a lifting device 3. It comprises four strain gauges R₁ to R₄ for each supporting structure 8 of the lifting device 3 of which two strain gauges R₁, R₂ are arranged on a first side wall 12 of the supporting structure 8 and the other two strain gauges R₃, R₄ are arranged on the second side wall 13 of the supporting structure 8. As indicated in FIGS. 3 and 4, in this case one of the strain gauges R₁ to R₄ is arranged on each side wall 12, 13 such that it detects vertical strain in the side wall 12, 13, whilst the other strain gauge R₁ to R₄ is arranged such that it detects horizontal strain in the side wall 12, 13.

In this case, the four strain gauges R₁ to R₄ for a supporting structure 8 are electrically connected together, as shown in FIG. 5. The two strain gauges R₁ to R₄ arranged together on a side wall 12, 13 are in each case electrically connected to a half bridge H₁, H₂, and the two half bridges H₁, H₂ are electrically connected on both side walls 12, 13 of a supporting structure 8 to a Wheatstone full bridge W. As shown in FIG. 5, a constant bridge voltage. U_{O}, for example of approximately 5V, is applied between the two half bridges H₁, H₂, and a measurement voltage U_{M} between the output terminals of the half bridges H₁, H₂ is supplied to a control unit 16 of the measuring device 15 and amplified and evaluated by the measuring device 15.

In FIG. 5 only the four strain gauges R₁ to R₄ for one of the supporting structures 8 of the lifting device 3 are shown here; the strain gauges R₁ to R₄ for the two other supporting structures 8 are in each case arranged in a similar manner on the side walls 12, 13 thereof, connected together and connected to the control unit 16.

The measuring device 15 in this case advantageously makes use of the fact that a leg load which acts on the support leg 5, causes stresses in the supporting structure 8 via the gear units 7 arranged on the supporting structure 8 which in turn cause strain in the supporting structure 8. This strain is detected by the strain gauges R₁ to R₄ arranged on the supporting structure 8, and by means of the control unit 16 the leg load acting on the support leg 5 is determined from the detected strain. The Wheatstone full bridges W function in this case in the known manner by exploiting the alterations to the electrical resistances of the strain gauges R₁ to R₄ caused by the strain. Thus when using the same strain gauges R₁ to R₄, a zero measurement voltage U_{M} is produced on the Wheatstone full bridge W if all of the strain gauges R₁ to R₄ are unexpanded. If, however, some of these strain gauges R₁ to R₄ are expanded or compressed, the measurement voltage U_{M} generally alters to positive or negative values.

In this case, the above-described arrangements, in particular the variable alignment of the two strain gauges R₁ to R₄ in the half bridges H₁, H₂ as well as the electrical connection of the strain gauges R₁ to R₄, have the result that measuring signals of these strain gauges R₁ to R₄, caused by bending stresses or torsional stresses or temperature changes in the supporting structure 8, mutually compensate one another so that leg loads which act on the support leg 5 substantially only in vertical directions are advantageously detected by the Wheatstone full bridges W.

The strain gauges R₁ to R₄ are also arranged on the supporting structures 8 such that they are located in supporting structure regions A to D of the supporting structures 8 which, on the one hand, are free from notch stresses so that the measurements of the strain in the supporting structures 8 are not influenced by such notch stresses and in which, on the other hand, stresses which are as high as possible are produced by a leg load in order to achieve sufficient measuring accuracy. In order to determine such supporting structure regions A to D, preferably a simulation of the stress distribution produced by a leg load in a supporting structure 8 is carried out, for example, by means of a corresponding finite element analysis of the stress distribution.

FIG. 2 also shows schematically a result of such a simulation. Differently shaded supporting structure regions A to D are shown, said regions differing with regard to the intensity of the stresses in a supporting structure 8 determined in the simulation, which are caused by leg loads acting on a support leg 5. In the supporting structure regions A, which are primarily located in the upper portions of the supporting structure 8, relatively small stresses caused by the leg loads have been determined. In the supporting structure regions B, which are primarily located in the central portions of the supporting structure 8, average stresses caused by leg loads have been determined. In the supporting structure regions C which are primarily located in the lower portions of the supporting structure 8, relatively high stresses caused by the leg loads have been determined. In the supporting structure regions D in which notch stresses occur, the greatest stresses caused by leg loads have been determined. These results of the simulation, therefore, suggest arranging the strain gauges R₁ to R₄ in the supporting structure regions C as the simulation results here reveal high stresses but no notch stresses. In these regions, in particular, the positions shown in FIGS. 2, 3, and 4 of the strain gauges R₁ to R₄ are located on the lower portions of the outer surfaces of the side walls 12, 13 of the supporting structures 8.

Although the invention in detail has been illustrated and described more specifically by a preferred exemplary embodiment, the invention is not limited by this disclosed example and other variants may be derived therefrom by the person skilled in the art without departing from the protected scope of the invention. In particular, for example, the measuring signals of the two half bridges H₁, H₂ arranged on the different side walls 12, 13 of a supporting structure 8 may be separately detected and determined by strain gauges R₁ to R₄, without the half bridges H₁, H₂ being connected to form a Wheatstone full bridge W. Alternatively or additionally, one respective temperature sensor may be arranged in the vicinity of these half bridges H₁, H₂, in order to detect temperatures in the supporting structure 8 and to identify strain caused by temperature changes and, if required, to incorporate said strain in the evaluation of the measurement results. Naturally, the invention is also not limited to the application to jack-up vessels 2 which have four lowerable support legs 5 and a deck 1 with a rectangular contour as in the described exemplary embodiment, but is similarly applicable to jack-up vessels 2 with a different number of lowerable support legs 5 or a different shape of deck 1, for example, to jack-up vessels 2 with three support legs 5 and a deck 1 with a triangular contour. Also, the number of gear units 7 of the lifting device 3 is not relevant to the invention, i.e. the invention also relates to lifting devices 3 having different numbers of gear units 7.

What is claimed is:

1-11. (canceled)

12. A method for determining a leg load which acts on a support leg of a jack-up vessel, said support leg being lowerable by a rack and pinion drive and said jack-up vessel having a supporting structure for at least one gear unit of the rack and pinion drive, the method comprising:
arranging on the supporting structure at least one strain gauge,
detecting in the supporting structure with the at least one strain gauge a strain caused by the leg load, and
determining the leg load from the detected strain.

13. The method of claim 12, further comprising:
arranging a plurality of strain gauges on the supporting structure, and
electrically interconnecting the plurality of strain gauges together, such that measuring signals from the electrically interconnected strain gauges caused by at least one of bending stresses, torsional stresses and temperature changes in the supporting structure mutually compensate one another.

14. The method of claim 13, wherein at least one pair of the strain gauges is arranged on the supporting structure such that the strain gauges of the at least one pair detect the strain in the supporting structure in different directions and wherein the strain gauges of each pair are electrically connected to form a half bridge.

15. The method of claim 14, wherein at least two pairs of strain gauges arranged on the supporting structure are electrically connected to each form a respective half bridge such that the strain gauges of each pair detect the strain in the supporting structure in different directions, and wherein the strain in the supporting structure detected by the at least two pairs is averaged for determining the leg load.

16. The method of claim 14, wherein at least two pairs of strain gauges arranged on the supporting structure are electrically connected to each form a respective half bridge such that the strain gauges of each pair detect the strain in the supporting structure in different directions, and wherein at least two of these pairs are electrically connected to form a Wheatstone full bridge for detecting the strain in the supporting structure caused by the leg load.

17. The method of claim 12, wherein each strain gauge is arranged in a region of the supporting structure that is free from notch stress.

18. A lifting device for a lowerable support leg of a jack-up vessel, wherein the support leg comprises at least one toothed rack extending parallel to a longitudinal axis of the support leg, the lifting device comprising:
a rack and pinion drive having at least one gear unit for the at least one toothed rack of the support leg,
a supporting structure having at least one supporting frame on which the at least one gear unit of the rack and pinion drive is arranged, and
a measuring device for determining a leg load acting on the support leg,
wherein the measuring device comprises
at least one strain gauge arranged on the at least one supporting frame for detecting a strain in the supporting frame caused by the leg load,
a control unit electrically connected to the at least one strain gauge and receiving measuring signals of the at least one strain gauge, and determining the leg load from the received measuring signals.

19. The lifting device of claim 18, wherein
at least one supporting frame comprises a rear wall and two side walls angled away from the rear wall,
at least one gear unit of the rack and pinion drive is arranged on the rear wall, and
at least one strain gauge is arranged on each of the two side walls.

20. The lifting device of claim 19, wherein at least one pair of strain gauges is arranged on each of the two side walls and is electrically connected to form a half bridge.

21. The lifting device of claim 20, wherein at least two pairs of strain gauges are arranged on different of the two side walls, which each pair electrically connected to a respective half bridge, wherein the half bridges are electrically connected to form a Wheatstone full bridge.
